(19) United States
(12) Patent Application Publication
(10) Pub. No.: US 2018/0039397 A1
(43) Pub. Date: Feb. 8, 2018

(54) SYSTEM AND METHOD FOR ORGANIZING AND PRESENTING DATA USING ZOOMING USER INTERFACE BLOCKS

(71) Applicant: Danila Medvedev, Moscow (RU)

(72) Inventor: Danila Medvedev, Moscow (RU)

(21) Appl. No.: 15/657,945

(22) Filed: Jul. 24, 2017

Related U.S. Application Data
(60) Provisional application No. 62/371,293, filed on Aug. 5, 2016.

(51) Int. Cl. G06F 3/0484; G06F 17/30

(52) U.S. Cl. CPC G06F 3/04845; G06F 17/30424; G06F 17/30572; G06F 2203/04806

(57) ABSTRACT

A zooming user interface system running on a computer displays data of different types and sources in blocks. Each significant information unit is framed into a block. The blocks can be zoomed, moved, copied, edited, deleted, prioritized and nested in unlimited levels. Each block can include an unlimited number of occupant blocks. Each occupant block resides inside an anchor block. The zooming user interface blocks support semantic scaling when zoomed. Furthermore, when a block is resized, its content is automatically scaled when displayed. The zooming user interface system also allows a user to save content data and the blocks, search information within all block data, edit block data and view block data. Regardless their respective content types, the blocks can be grouped by a user to their preferences. All relevant information of a user is kept in one place.

### CROSS REFERENCE TO RELATED APPLICATIONS

This application claims the benefit and priority of U.S. Patent Application No. 62/371,293, entitled “SYSTEM AND METHOD FOR ORGANIZING AND PRESENTING DATA USING ZOOMING USER INTERFACE BLOCKS,” filed Aug. 5, 2016, which is hereby incorporated by reference in its entirety.

### FIELD OF THE DISCLOSURE

The present invention generally relates to a computer system and method for organizing data and presenting the data to users, and more particularly relates to a computer system and method for organizing data and presenting data using blocks. More particularly still, the present disclosure relates to a computer system and method for organizing data based on blocks and presenting data using a zooming user interface with blocks.

### DESCRIPTION OF BACKGROUND

As more and more information becomes available, there is a strong need to effectively organize it, and put it in a desired order. First attempts to give data items some structure were taken millenniums ago. For example Great Library of Alexandria was home to some 500,000 scrolls, which were divided into 11 categories, and enumerated by authors' names. Though this system was not perfect, scholars knew where to find the information they were interested in. With the number of documents constantly increasing, new methods of structuring data were developed. The very basic element(s) of data storage that we have today (such as pigeonhole classification or file cabinets with vertical separation of documents) were not known to prior generations, and were only invented within the last 200 years.

There are generally two parts to the problem of how to organize information. First is how to store data while the second part is how to navigate through (find, present, and update) that data. It should be noted that the way data is structured limits the way data can be displayed.

There are multiple ways data can be structured, such as directory/file systems, databases, hyperlinks and hypertext, etc. Classic directory/file structures are used in Microsoft Windows and other popular systems. Such a structure is associated with numerous issues, such as that data can only be grouped structurally by placing files in the same directory, and limited ability to work with files according to a content of the files. Search and navigation through files and folders take long time, and are thus impractical for large quantity of data. For example, documents that exist deep in the folder structure are hard to locate. In addition, the folder/file structure is constructed statically with each file having a path and depending on all directories it is located in. It thus creates multiple errors and issues when moving or referencing files. Files and directories (also referred to herein as folders) are the basic units of the system and cannot be converted into each other. Accordingly, this structure limits the ability to operate files and folders uniformly.

Database (such as a relational database) is another type of system designed to organize datasets of different sizes. Information in databases can be easily processed (such as grouping, sorting, filtering, calculating, etc.). However, databases only work with specific types of input data. Unstructured data (such as random music, pictures, text notes, external devices, etc.) can be only processed if a specific tool is provided by a computer developer.

World wide web is another great tool to group and present data to users. The web allows adding external objects to a page. To use such objects, however, external plugins are required, and all objects on the web are only displayed as results produced by the plugins. There is very limited communication between objects, and blocks are basically static inserts, and user has to work with each of them manually. Hypertext and hyperlinks significantly improve the data grouping to allow quick and intuitive navigation through data patterns. However, they are incapable to integrate multiple pieces of data from different sources, and are just conduits to places where data is located.

Navigation through data in another side of the challenge of effectively organizing data. Finding some information can be easy these days using online search engines. However, finding all relevant data on a topic is not convenient, and can be very difficult. Searching on Google.com provides multiple pages containing the same or very similar information. However, finding, grouping, comparing, analyzing all relative fragments in one place is not a trivial task, which is not provided by Internet search engines, such as Google.com.

In the middle of the 20th century, Vannevar Bush, an American engineer and inventor, offered a new concept of managing information. In his publication “As We May Think”, he offered a mechanism to photograph users' books, records, communication, store them on microfilms, and group, sort and present the data via slides on a machine he named Memex. The system consists of desk with levers and buttons. It includes intuitive mechanisms of control, microfilm storage and projector. In Memex, millions of volumes could be compressed to a size to fit in a small closet. Using indexes, users were able to find information they desire. His concept of structuring data led to development of computers.

First graphical user interfaces (“GUI”) were developed in 1960s. Inspired by the concept of Memex machine, Douglas Engelbart at the Augmentation Research Center developed the oN-Line System (“NLS”). This computer incorporated a mouse-driven cursor and multiple windows used to work on hypertext. Information was broken down and grouped by blocks and each block could be edited separately. The system was very intuitive and based on how children learn. The design was based on the childlike primitives of eye-hand coordination, rather than use of command languages, user-defined macro procedures, or automated transformations of data as later used by adult professionals.

Further development of GUI led to creation of Alto personal computer by Xerox PARC. Alto (and later Xerox Star) is considered the first serial system that implemented a GUI. It wasn't a commercially successful product, but greatly influenced the whole industry of personal computers.

Later, the model of Xerox PARC led to creation of multiple GUI interfaces like SGI MEX, DRI Graphical Environment Manager (“GEM”), DeskMate, Workbench and others. The most notable is the Lisa computer, the first personal computer released by Apple Inc. in 1983. The GUI based X Window system was originated at MIT and used on UNIX like systems. Windows systems are GUIs developed by Microsoft Corporation.

Few later projects after NLS, notably ZOG and VIKI, used information blocks placed in one general workspace, allowed internal data and external hyperlinks and hypertext to be contained in these blocks, and provided direct access to data contained in blocks. Unfortunately, such systems were not fully developed, and later discontinued. There were hundreds of other attempts to create uniform systems. They all failed to become a fully integrated platform for easy and fast processing of large volume of structured and unstructured data, of multiple formats and sources, and to group and display the relevant data in one simple interface.

In recent years, there is a general trend in information technology (“IT”) industry to step away from a classic directory/file system to more modern web applications that visually combine text, video, pictures in a single place. However, there are still no effective tools to combine and present any and all type of data in one standardized format. All existing alternatives have restrictions and limitations in different ways. None of the previous attempts was successful in developing a fully integrated and universal platform. They are either too restricted to their narrow fields, or are incapable to organize all relevant information if used as a general tool.

Accordingly, there is a need for a system and method that effectively organizes and presents data, structured or unstructured. There is a further need for a computer system and method for effectively organizing and presenting different types of data using nested blocks of multiple levels navigated via a zooming user interface (“ZUI”). The new system processes data faster than alternatives.

### SUMMARY OF THE DISCLOSURE

Generally speaking, pursuant to the various embodiments, the present disclosure provides a system and method for efficiently organizing information. The system includes a computer running a special zooming user interface software application. The computer communicates with other computers, such as servers and cloud computers, over the Internet. Furthermore, the computer is adapted to be operatively coupled to other data sources, such as a hard disk drive, a flash drive (such as a USB drive), sensors, video cameras, etc. The zooming user interface software application organizes data by allowing user to define significant information units, which are framed and displayed in the zooming user interface blocks.

Each zooming user interface block can include any number of occupant blocks. The occupant blocks are anchored in the host block. The host-occupant nesting relationship can extends to unlimited number of levels. Blocks can be moved or copied into other blocks, deleted, resized, zoomed, edited, viewed, hidden, activated by internal script or external application, etc.

One of the ZUI core features is zooming. Zooming in means increasing displayed content, showing additional details in effect moving the user viewpoint closer to the content. Zooming out is the reverse. It reduces the size of the content by displaying a larger overview instead and hiding details gradually. Zooming is smooth allowing continuous zooming. Alternatively, it can be performed in steps. Zooming can be initiated by the user using various user interface mechanisms (such as touch screens, mouse wheel, keys, etc.) or by the system itself as a reaction to certain triggers (such as during search). When ZUI detects that zooming is happening, the relevant part of the information map is redrawn. Each block visual representation is recreated with auto layout algorithms called and a new layout created. The overlay is redrawn and other aspects of the ZUI are redrawn. This can be done using software rendering on a CPU or (including partially) hardware rendering on a GPU. Content that needs to be displayed after zooming in or out can be taken from local cache, downloaded from the network dynamically or requested in advance (such as pre-loading). If parts of the content are not available, approximations (such as lower resolution images or object placeholders) can be used instead. The display of the blocks is not delayed because parts or all content are not available. Some objects (such as blocks or groups of blocks) can be made temporarily exempt from zooming (pinned to the screen or activated).

Automatic layout is implemented. It means that blocks are laid out on the screen automatically based on their content for viewing/reading/editing. In conventional systems, the user is responsible for placing windows and content in windows on the screens. An alternative is static (such as template-based or hardcoded) layout common for most applications and websites. In the ZUI system, navigation through the structure of the information and display of the content are combined into a single interface and layout algorithms used are the same. Zooming allows showing any block with any required level of detail (for gradually getting closer to it). At each scale automatic layout places the blocks so that they fill the available (i.e., visible) space on the screen optimally. Different layout modes are available, including flow, vertical, free, treemap, etc. The user can choose the desired mode, for any block and its occupants, or the system can pick the optimal mode based on the hierarchy of the blocks, their content, available screen space and other factors.

Each block displays its content. When the block is zoomed, its content is also semantically scaled. The zooming user interface system allows a user to search for information based on keywords. The search is conducted against content data of all blocks. The search scope encompasses the entire information collection. The zooming user interface system also allows a user to adjust the level of details of display of the blocks on the computer. As a source block, each block can be referenced in multiple locations. The referenced blocks can be displayed in a portal. Editing in the portal is also reflected in the source block. Deletion of a portal does not affect the source block

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a simplified block diagram of a system for organizing data using nested blocks navigated by a zooming user interface in accordance with this disclosure.

FIG. 2 is an illustrative single zooming user interface block in accordance with the teachings of this disclosure.

FIG. 3 is an illustrative zooming user interface host block with two occupant blocks in accordance with the teachings of this disclosure.

FIG. 4 is an illustrative group of zooming user interface blocks in accordance with the teachings of this disclosure.

FIG. 5 is an illustrative group of zooming user interface blocks in accordance with the teachings of this disclosure.

FIG. 6 is an illustrative list of a host block and its first level occupant blocks in accordance with the teachings of this disclosure.

FIG. 7 is an illustrative set of zooming user interface blocks in accordance with the teachings of this disclosure.

FIG. 8 is an illustrative set of zooming user interface blocks in accordance with the teachings of this disclosure.

FIG. 9 is an illustrative set of zooming user interface blocks in accordance with the teachings of this disclosure.

FIG. 10 is an illustrative set of zooming user interface blocks in accordance with the teachings of this disclosure.

FIG. 11 is an illustrative set of zooming user interface blocks in accordance with the teachings of this disclosure.

FIG. 12 is an illustrative set of zooming user interface blocks in accordance with the teachings of this disclosure.

FIG. 13 is an illustrative set of zooming user interface blocks in accordance with the teachings of this disclosure.

FIG. 14 is an illustrative set of zooming user interface blocks in accordance with the teachings of this disclosure.

FIG. 15 is an illustrative zooming user interface system in accordance with the teachings of this disclosure.

FIG. 16 is an illustrative zooming user interface system in accordance with the teachings of this disclosure.

FIG. 17 is an illustrative zooming user interface system in accordance with the teachings of this disclosure.

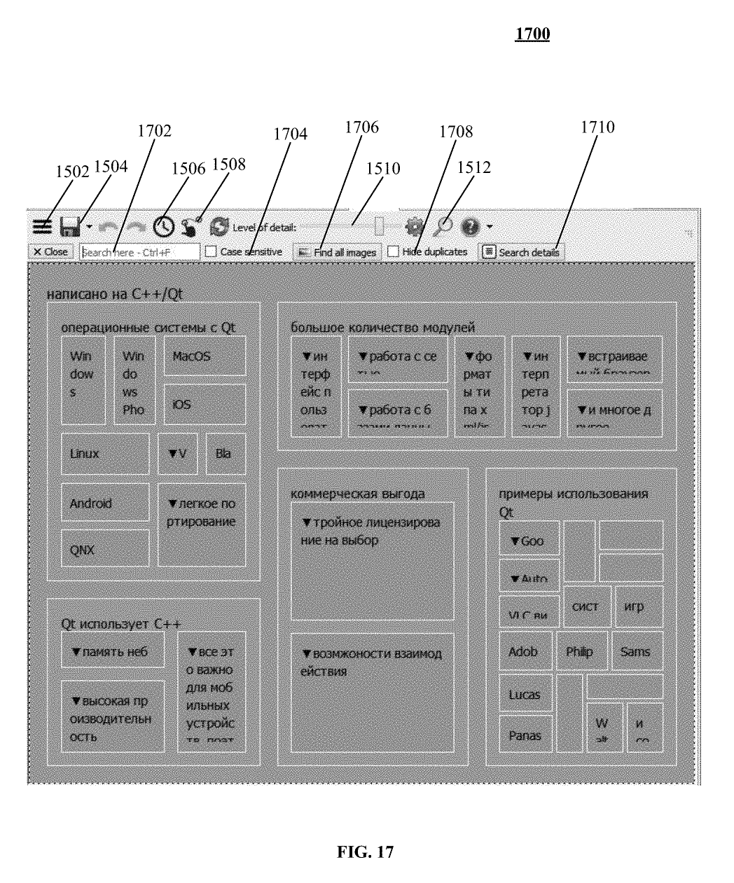

FIG. 18 is an illustrative zooming user interface system in accordance with the teachings of this disclosure.

FIG. 19 is an illustrative set of zooming user interface blocks in accordance with the teachings of this disclosure.

FIG. 20 is an illustrative zooming user interface system allowing users to view history of editing in accordance with the teachings of this disclosure.

FIG. 21 is an illustrative set of zooming user interface blocks in accordance with the teachings of this disclosure.

FIG. 22 is an illustrative set of zooming user interface blocks in accordance with the teachings of this disclosure.

FIG. 23 is a sample screen for configuring item properties of a zooming user interface in accordance with the teachings of this disclosure.

FIG. 24 is an illustrative block diagram showing horizontal connections between blocks of a zooming user interface in accordance with the teachings of this disclosure.

A person of ordinary skills in the art will appreciate that elements of the figures above are illustrated for simplicity and clarity, and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skills in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

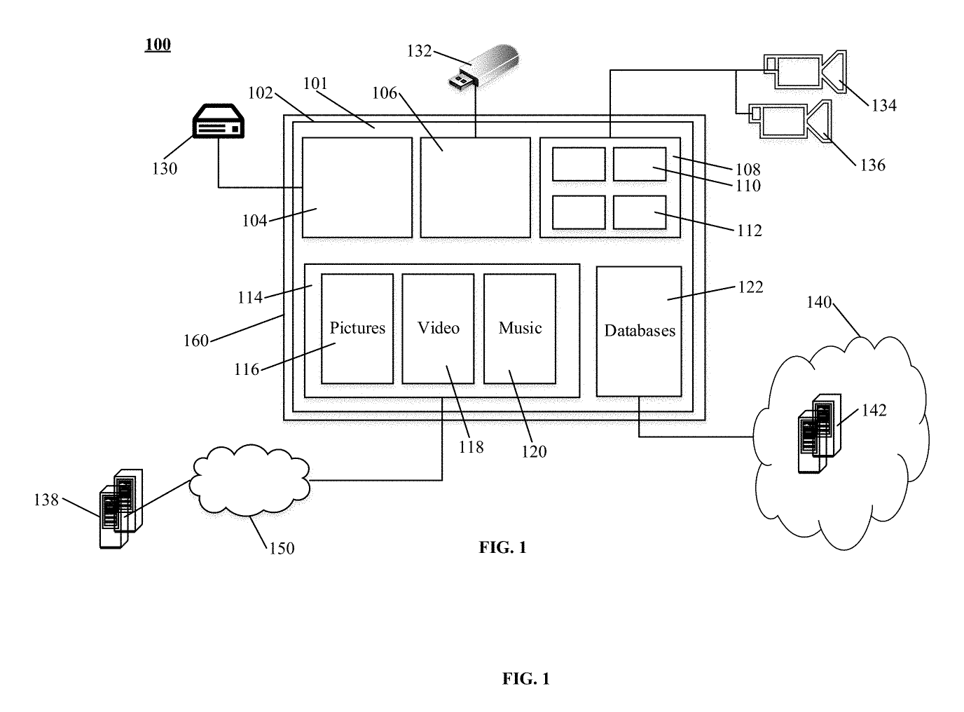

Turning to the Figures and to FIG. 1 in particular, a system for efficiently organizing data in blocks that are navigated through a zooming user interface is shown and generally indicated at 100. The illustrative system 100 includes a zooming user interface 102 displayed on a computer 160, which can be a desktop computer, a laptop computer, a tablet computer, a smartphone, cloud computers, servers, etc. The ZUI 102 includes multiple ZUI blocks 101, 104, 106, 108, 110, 112, 114, 116, 118, 120 and 122. The ZUI block 101 is the anchor to the ZUI blocks 104,106,108,114 and 122. The ZUI blocks 104, 106, 108, 114 and 122 are said to be occupants of the ZUI block 101. The ZUI block 108 is the anchor of its occupants 110 and 112. The ZUI block 114 is the anchor of its occupants 116,118 and 120.

The ZUI blocks are nested at multiple levels without limitations. Each ZUI block presents data from a source. For example, the ZUI block 104 displays captured data from a local storage disk 130; the ZUI block 106 presents data from a flash drive 132; the ZUI block 108 presents data from one or more cameras 134-136; the ZUI block 114 and its occupants 116-120 present data from one or more server 138 over a wide area network 150 (such as the Internet); and the ZUI block 122 presents data stored in a cloud server 142 within a cloud 140. The cloud server 142 can be a cloud database server.

The ZUI system 102 frames each significant unit of data into separate standardized blocks. Blocks can be inserted into each other. Navigation through the blocks is achieved using the zooming user interface 101-122. When the ZUI blocks 101-122 are displayed, their content is automatically scaled. As a single interface, the ZUI system 102 works with any well-structured data (such as data in relational databases), and any number or types of unstructured data (such as text, pictures, video, etc.). Navigation through the data in the system 102 is very simple; and the time for finding any piece of information is significantly decreased compared to other alternatives.

Each significant information unit can be defined by a user and is framed into a block. Blocks can be semantically zoomed. In other words, the level of details of a block is changed and content is presented to fit the current size of the corresponding ZUI block. For instance, when the ZUI block is larger, more content of the block is displayed.

The ZUI system 102 displays data in ZUI blocks. Data is informational objects. A ZUI block is an area with or without frame with information inside the area shown in the form of text, picture, video, etc. Each ZUI block has a unique identifier attribute that uniquely identifies the ZUI block within the system. The ZUI block can also have other attributes and other attributes, such as date, address, name, etc. The attributes allow identification of ZUI blocks. Each ZUI block has an anchor block (also referred to herein as a host block) in which the ZUI block is located. The ZUI block is termed as an occupant block of the anchor.

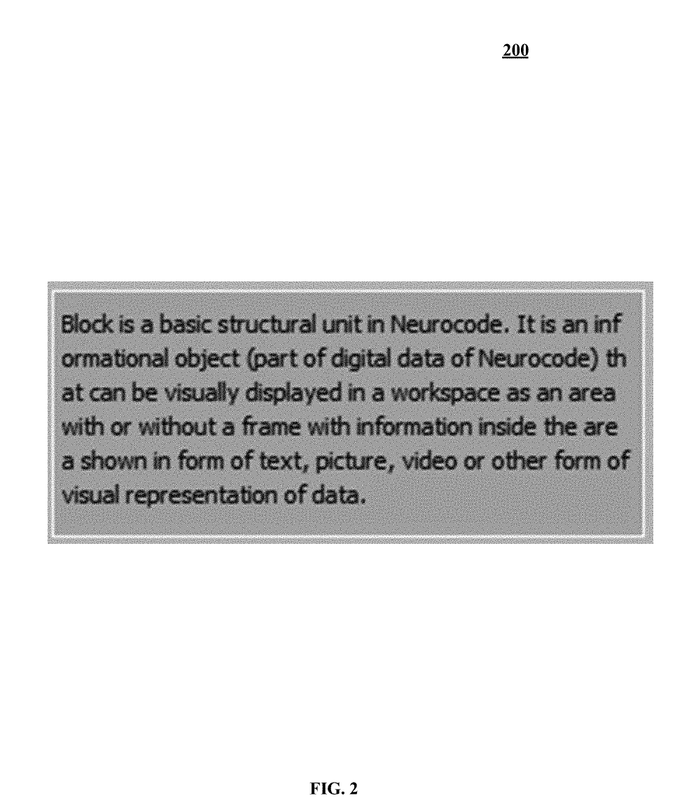

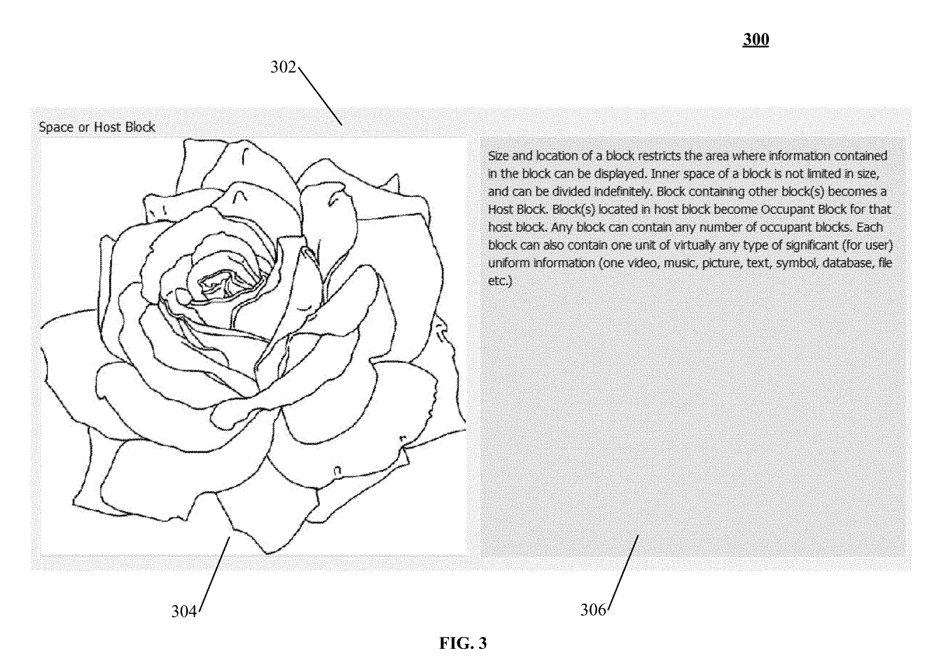

Size and location of a ZUI block restricts the area in which information contained in the block is displayed. Inner space of a ZUI block is not limited in size, and can be divided indefinitely. Any ZUI block can contain any number of occupant blocks. Each ZUI block can contain one unit of any type of significant uniform information (such as one video, music, picture, text, symbol, database, file, etc.). Multiple units of information can exist in a ZUI block as well. A ZUI block allows operation on the data it displays as a single entity. A block is a basic unit, and the only structural unit in the system 102. Thus, the system 102 can treat all units the same way making the system 102 more standardized. All basic operations with ZUI blocks (such as copy, move, delete, insert, etc.) can be performed in the same way regardless of their content. An illustrative single ZUI block is shown in FIG. 2; and a host block with two occupants are shown in FIG. 3 at 203, 304 and 306 respectively.

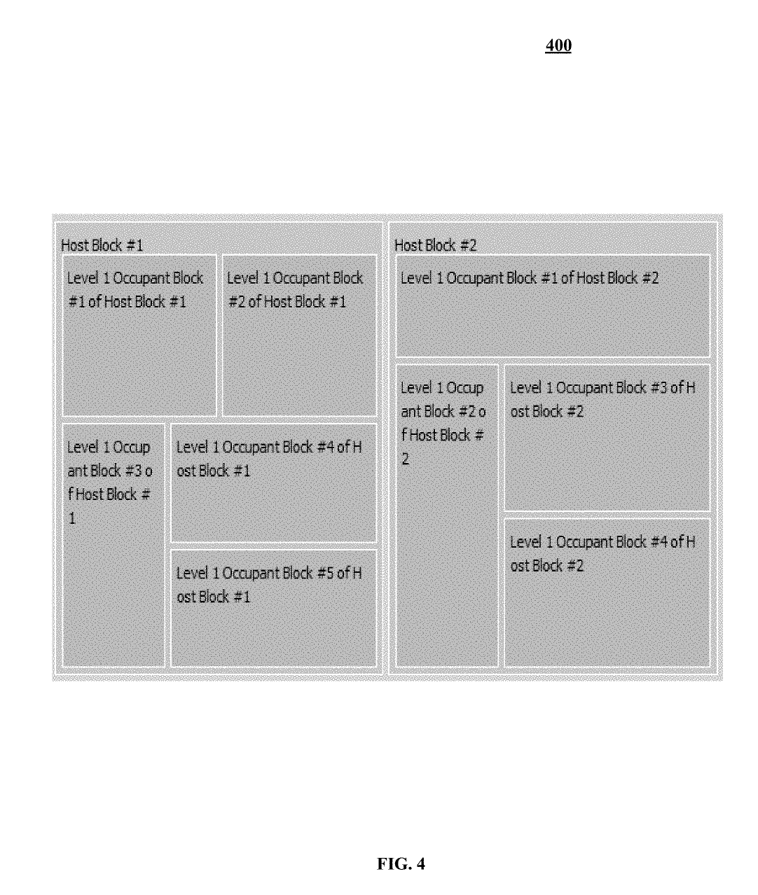

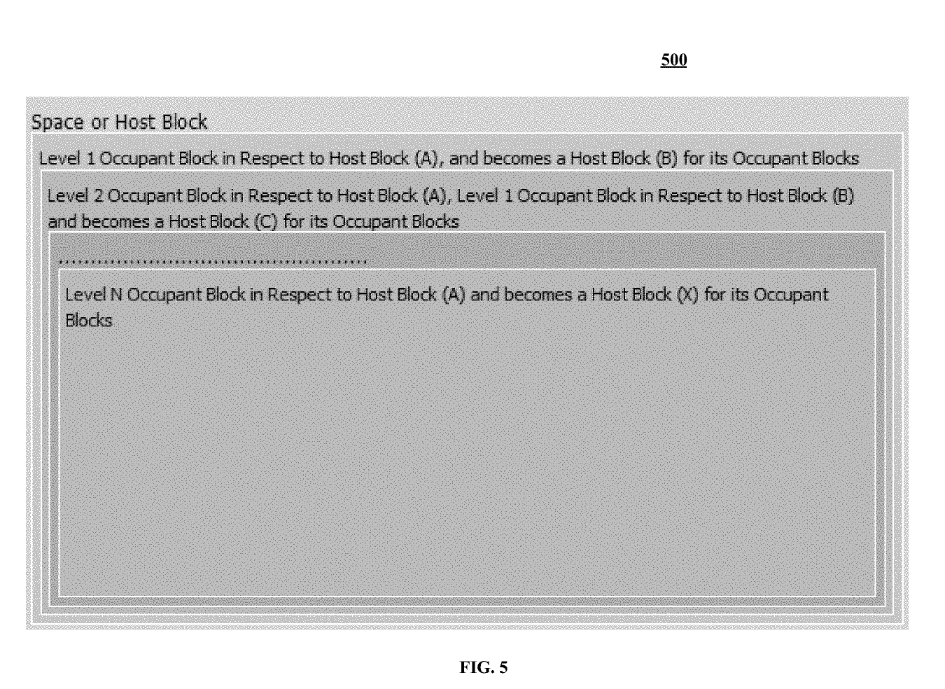

Any ZUI block can contain unlimited number of Occupant Blocks (“OBs”). Any occupant block can also contain unlimited number of OBs of its own, and so on. All ZUI blocks located directly in a host block become level 1 OBs for the host block. ZUI blocks located directly in level 1 OBs (also referred to herein as first level OBs) become level 2 OBs (also referred to herein as second level OBs) in respect to the host block, and level 1 OBs of the level 1 OBs of the host block. Level of insertion of ZUI blocks is unlimited. Two illustrative groups of ZUI blocks are shown in FIGS. 4 and 5 respectively.

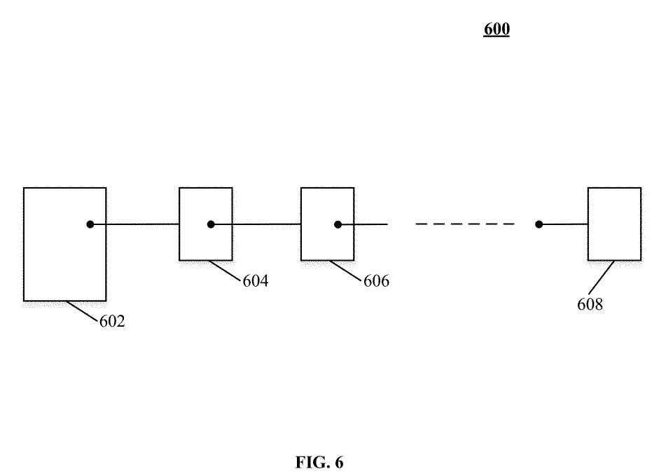

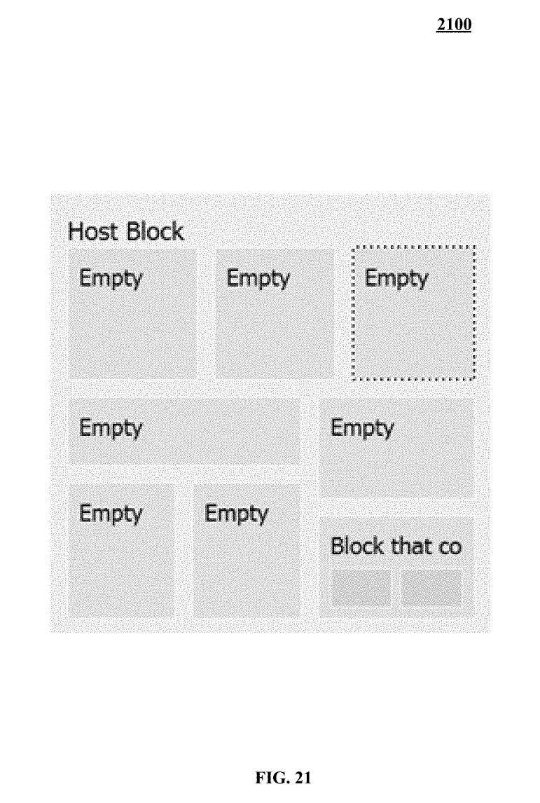

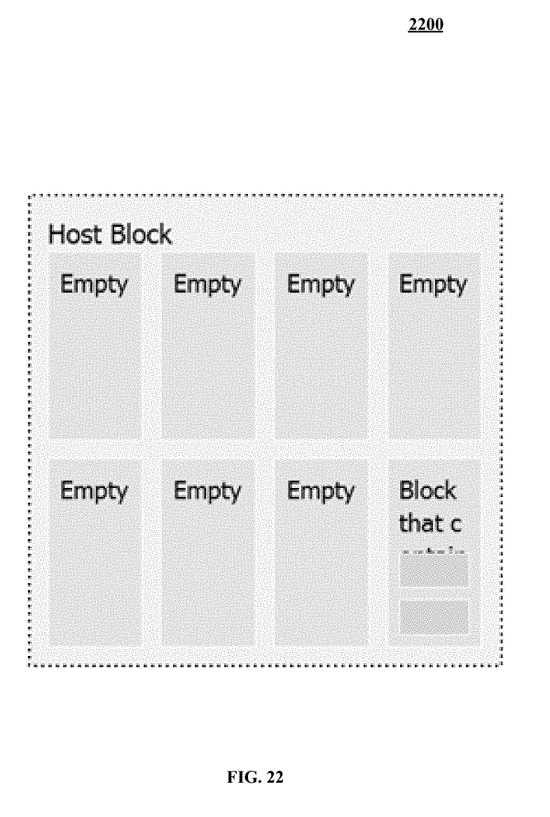

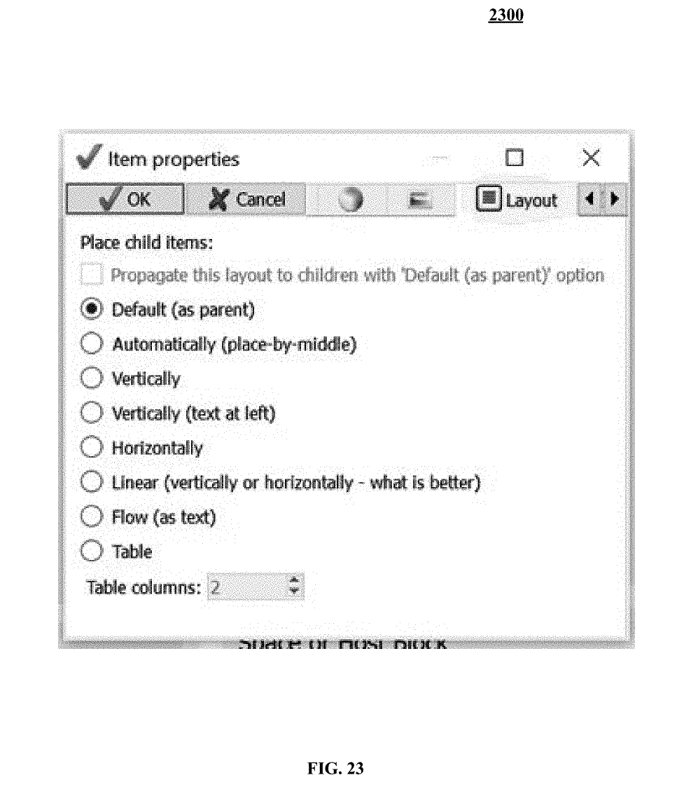

In one implementation, a host block and its first level OBs are represented by a list. An illustrative list of a host block and its first level OBs is shown in FIG. 6 and indicated at 602 and 604-608 respectively. Occupant blocks can be rearranged or sorted in multiple different manners, horizontally, vertically, as text, as table, etc. The arrangement is further illustrated by reference to FIGS. 21, 22, and 23. FIG. 21 shows a group of blocks, while FIG. 22 shows the same blocks after a rearrangement. The rearrangement can be initiated and controlled by a user interface shown in FIG. 23.

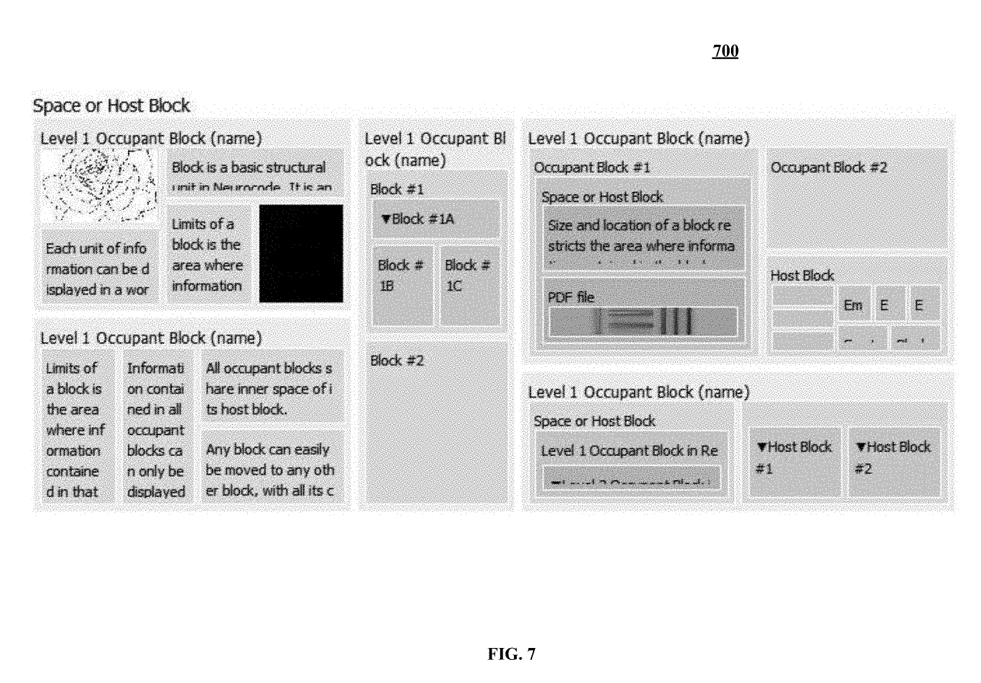

All ZUI blocks are placed and displayed on the workspace 102. The workspace 102 is an infinite field where ZUI blocks can be located and continuously navigated. ZUI blocks located directly in the workspace 102 are level 1 occupant blocks (i.e., first level occupant blocks). ZUI blocks placed inside level 1 blocks are level 2 occupant blocks (i.e., second level occupant blocks) in respect to the workspace 102 and level 1 occupant blocks in respect to a corresponding level 1 block, and so on. All occupant blocks are displayed within corresponding host blocks. If the room to display a ZUI block or its containment is insufficient, the information will be shown in partial, or not shown at all. All occupant blocks are automatically scaled to fit in the host block. If ZUI blocks are added or removed, or the size of some occupant block(s) is changed, all other ZUI blocks are then resized to better fit and display information within their host block. An illustrative set of ZUI blocks is further illustrated by reference to FIG. 7.

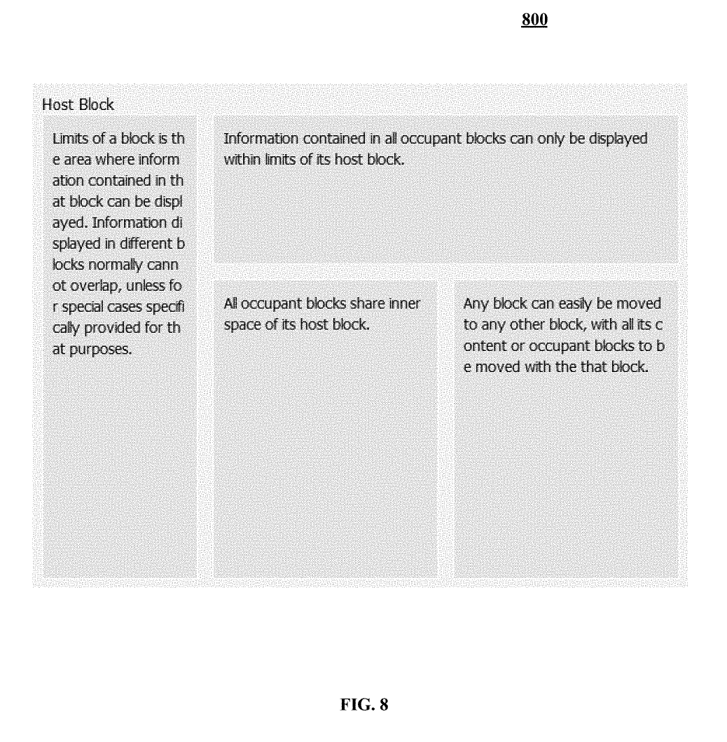

Each ZUI block includes an area for displaying information. The displayed information is framed inside the display area. Information displayed in different ZUI blocks usually does not overlap. Occupant blocks are within the boundary of their anchor block. All occupant blocks share inner space of its host block. Accordingly, information contained in occupant blocks is not displayed outside of their host block. ZUI block boundary is further illustrated in FIG. 8.

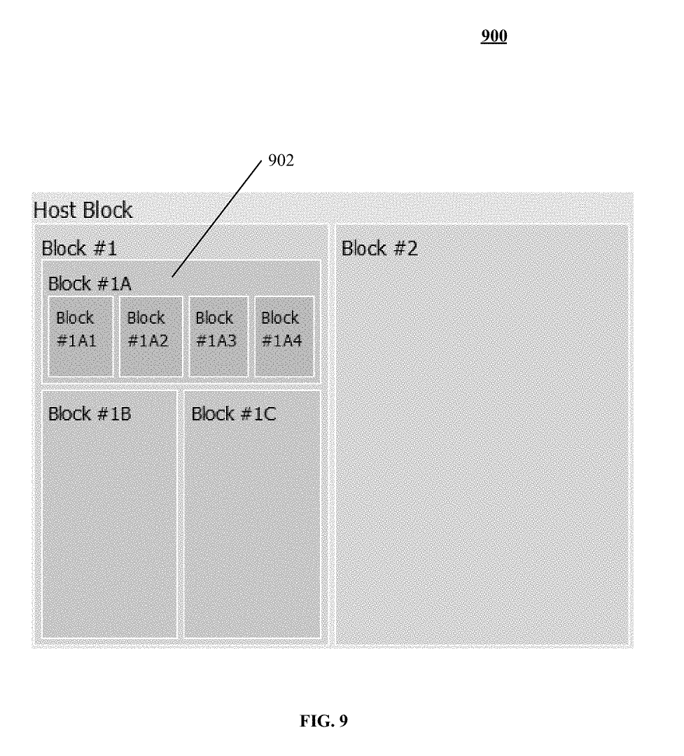

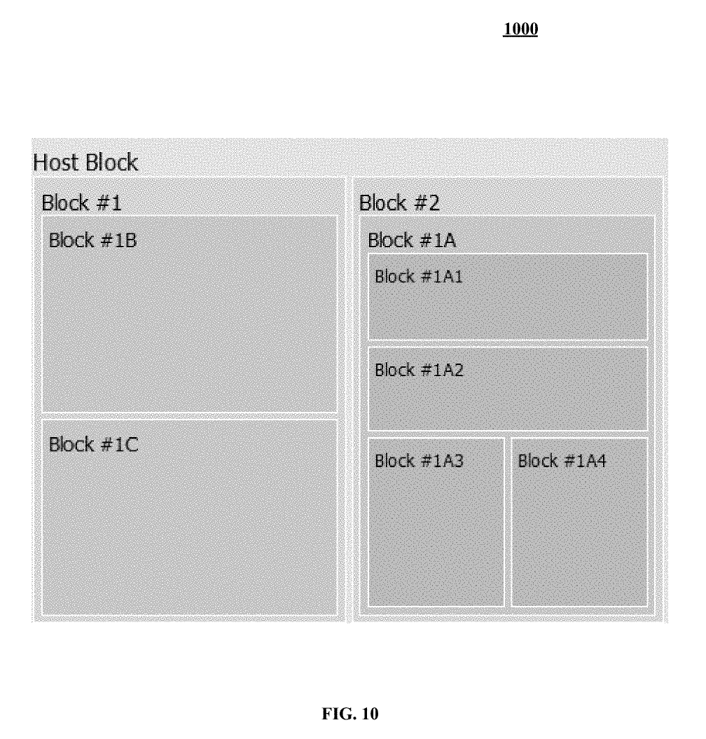

ZUI blocks can be moved or copied to any other block. In such a case, the occupant blocks of the moved or copied block are moved or copied with it. The data contained in the moved or copied block and its occupant blocks are still associated with the moved or copied blocks. In other word, when a ZUI block is copied or moved, the content displayed inside the ZUI block continues to be displayed in the ZUI block after the copying or moving. ZUI block moving is further illustrated by reference to FIGS. 9 and 10.

Referring to FIGS. 9 and 10, FIG. 9 shows blocks #1 and #2 before block #1A is moved into block #2. FIG. 10 shows blocks #1 and #2 after block #1A is moved into block #2. To move the block #1A, a user moves a mouse cursor to the title area of block #1A and drags block #1A into block #2 before releases the user's left mouse button. The title area of block #1A is, for example, a horizontal bar 902 displaying text “Block #1A.” In one implementation, the block #1A is removed from the list of occupant blocks of Block #1, and inserted into the list of occupant blocks of Block #2 when the block #1A is moved from Block #1 to Block #2.

ZUI blocks and their content data can be referenced in multiple locations. When a block is referenced, it is termed as the source block in the reference relationship. In addition, each block can have one or more portal(s). A portal is a block displaying referenced blocks. All changes done to a block within a portal is reflected in the source block, and vice versa. Deletion or change in priority of a portal does not affect the main block.

Navigation is continuous in the entire space 102. Any location in the workspace 102 can be zoomed in and zoomed out. Sizes of blocks visible within the screen increase or decrease when the blocks are zoomed. In addition, when a ZUI block is zoomed, its occupant blocks and information framed in the ZUI block and its occupant blocks are automatically scaled and displayed. The scale is based on the content. For example, when zoomed, a ZUI block and the content (such as text) displayed within it are scaled. Alternatively, the size of text content is not scaled when the ZUI block is zoomed. As a further alternative, blank space is used to display the content when the ZUI block is zoomed.

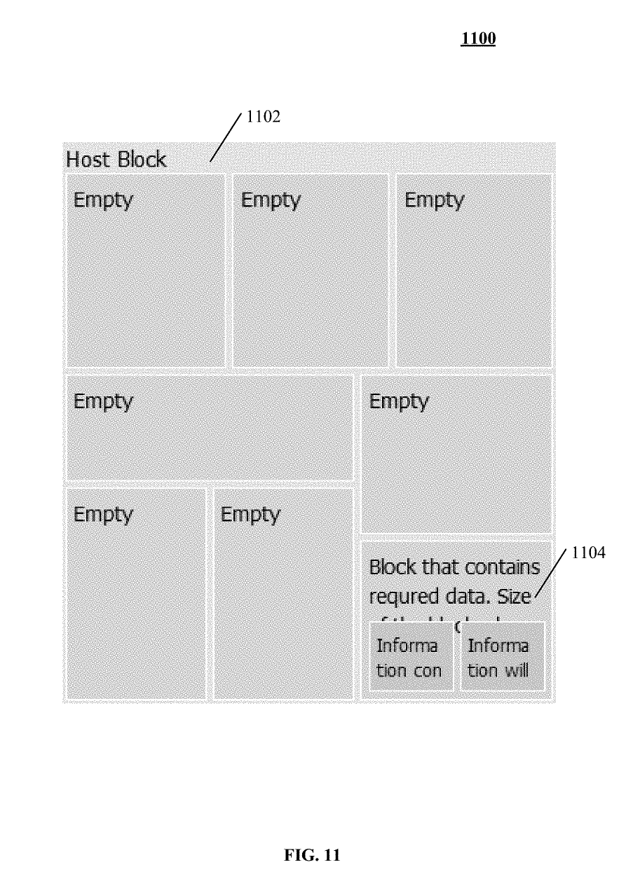

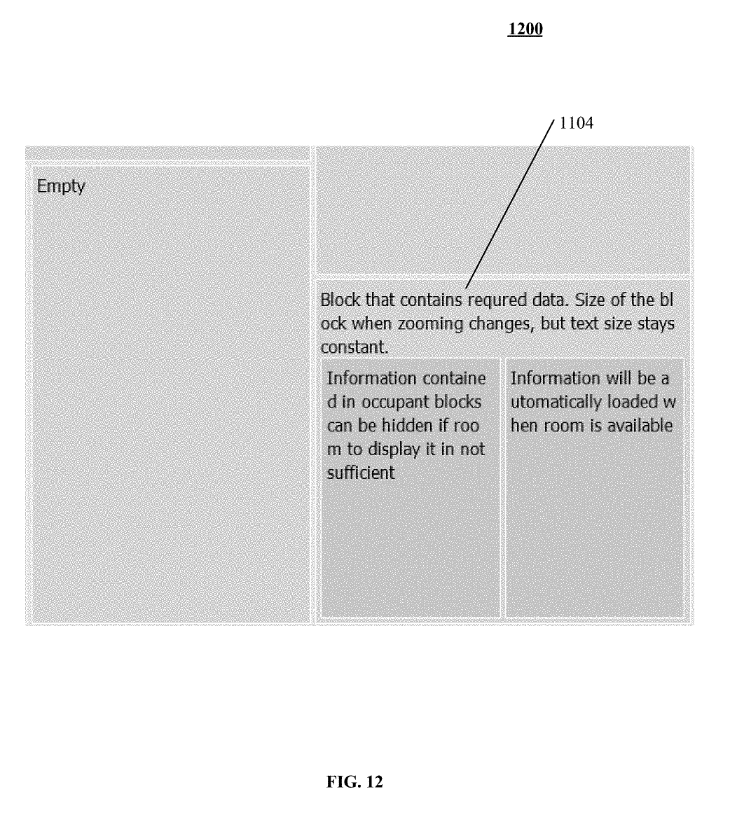

The case when the text content is not resized when the ZUI is zoomed is further illustrated by reference to FIGS. 11 and 12. When the block 1102 is zoomed, the text size of the block 1104 and its occupant blocks is not changed. More content is thus displayed in the block 1104 and its occupant blocks after the zooming.

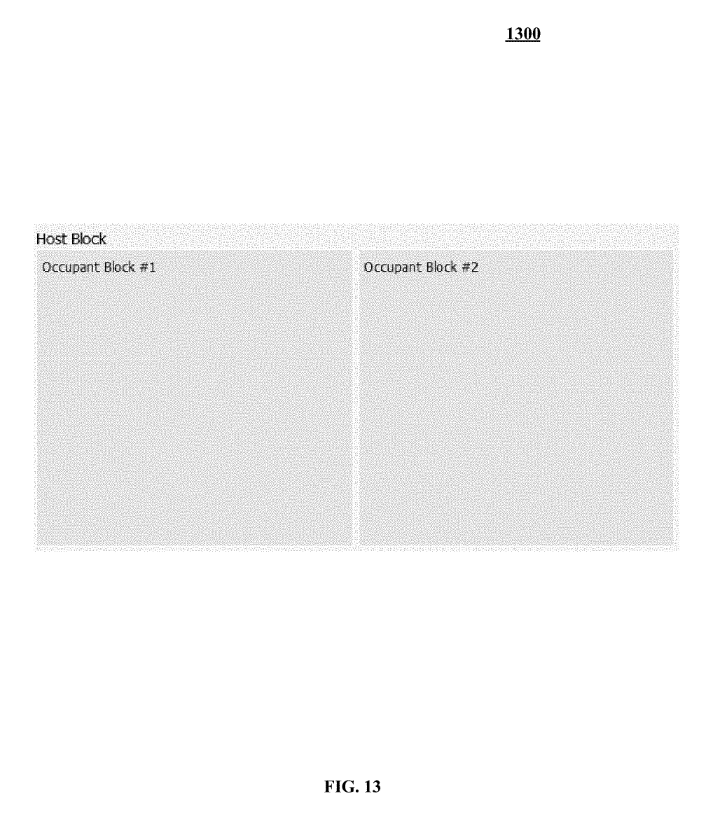

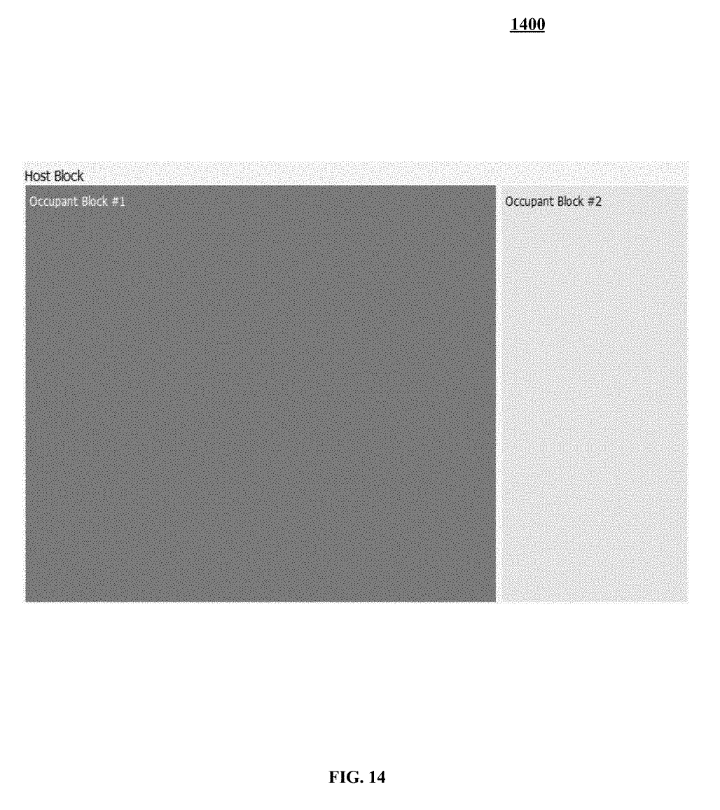

Each ZUI block has a priority level. Priority level can be changed by a user, or by the computer program implementing the ZUI system 102 in an automatic manner based on usage history, user input or other reasons. Visual representation of priority level increase or decrease can be reflected as proportional change in size, color, text style, blinking and symbols of a block or by adding extra components such as frame, markers, sound to that block. An illustration of the priority indication is shown in FIGS. 13 and 14. FIG. 13 shows the Host Block and its two occupant blocks Occupant Block #1 and Occupant Block #2. When the priority of the Occupant Block #1 is changed to a higher priority, its size is increased as shown in FIG. 14.

The ZUI system 102 further incorporates additional unique features, such as simple conflict resolution, history of changes and editing versions, multiple user support, online and offline integration, filtering information, blocks secondary attributes, multiple language, search, and so on.

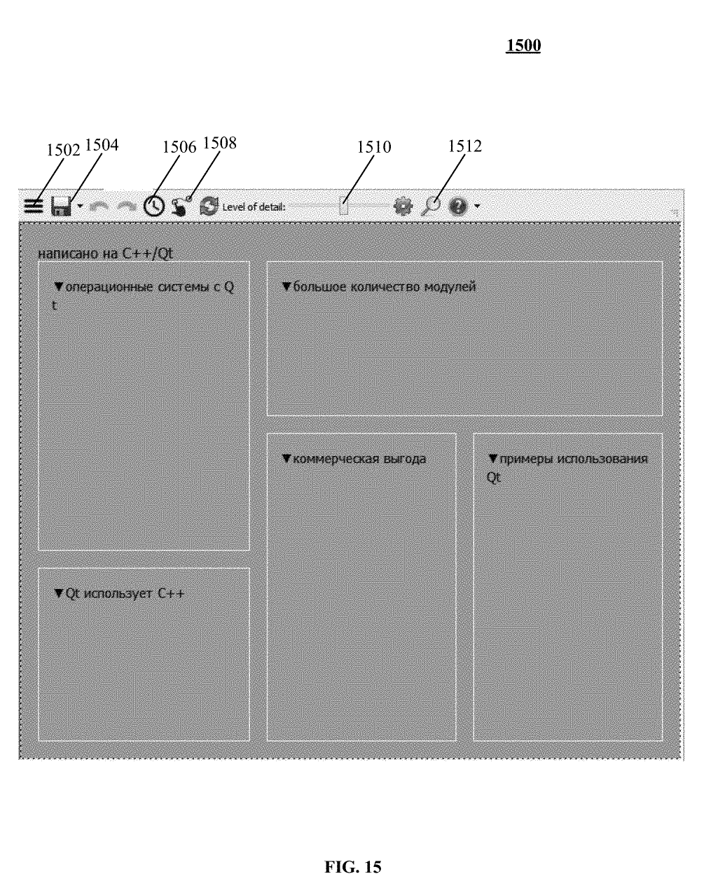

Turning to FIG. 15, one illustrative implementation of the ZUI system 102 is shown and generally indicated at 1500. The ZUI system 1500 includes a menu button 1502, clicking of which brings up menu allowing a user to perform various functions. The ZUI system 1500 also includes a save button 1504 allowing a user to save the ZUI system 1500 with changes to data and ZUI blocks. In addition, the ZUI system 1500 includes a history button 1506, an edit button 1508, a detail level control 1510 and a search button 1512.

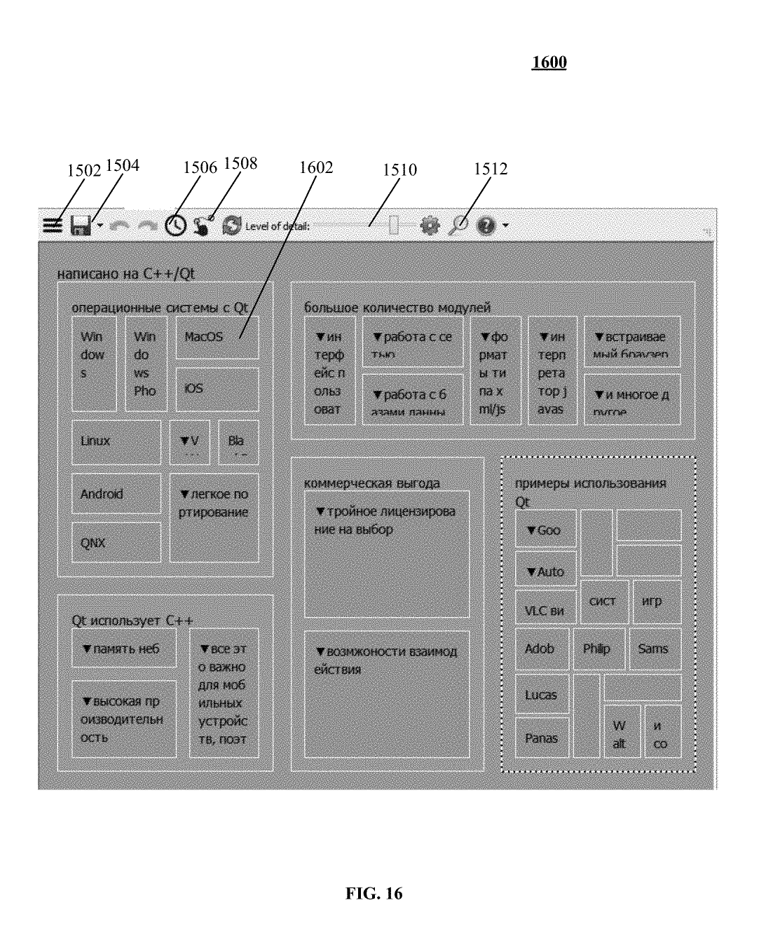

Moving the sliding bar 1510 causes the ZUI system 1500 to zoom in or out. For example, when the control 1510 is slided to the right, more details of the ZUI system 1500 is displayed as shown in FIG. 16. Moving the sliding bar 1510 increases or decreases the level of detail (or depth) shown in occupant blocks. For example, at the very left position, only the host blocks are shown. When the sliding bar is moved to the right, deeper level occupant blocks are shown.

When the search button 1512 is clicked, the ZUI system 1500 displays search controls 1702-1710 allowing a user to search for information. In the search control 1702, a user enters keyword(s). A search engine of the ZUI system 1500 then searches all of its block contents for relevant information. In other words, the ZUI system 1500 locates all relevant information pertinent to the keyword(s) from all data sources, not a limited scope (such as one folder, one file, one table in a database, etc.) It searches to all blocks starting in current host block and down to particular occupant blocks. If a user zooms out to a higher level host block, the system will research. The control 1704 controls the case sensitivity of the search. The search control 1706 allows a user to search for images. The control 1708 allows a user to determine whether the search result list includes duplicate results. The search control 1710 controls the search details.

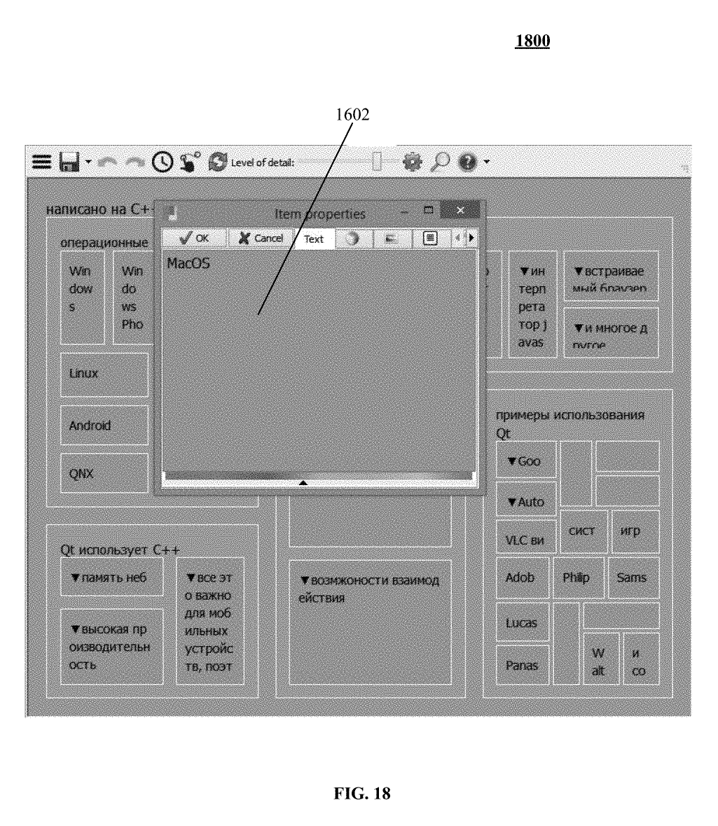

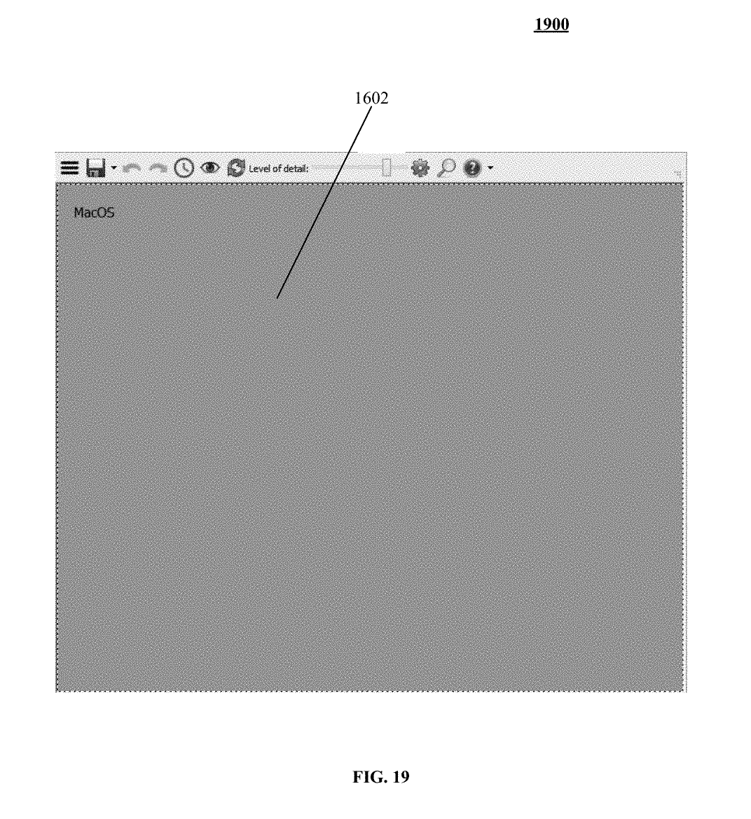

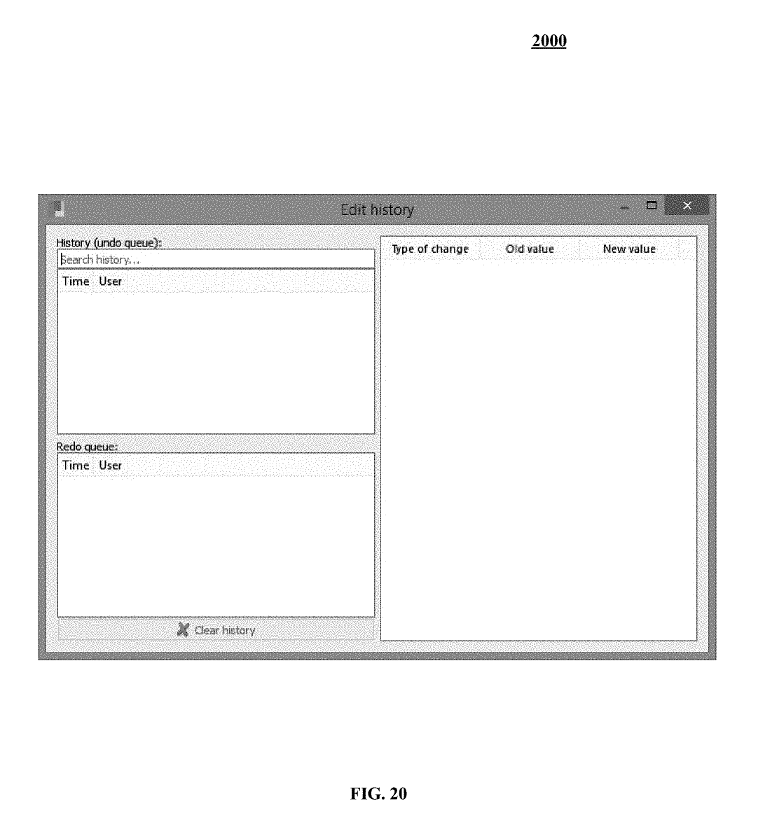

The editing control 1508 is a toggle between a viewing mode and an editing mode. In editing mode, clicking on a ZUI block allows a user to edit the content data of the ZUI block. For example, a ZUI block 1602 in editing mode is shown in FIG. 18. The ZUI block 1602 in viewing mode is shown in FIG. 19 at 1902. When the editing mode is on, clicking the history button 1506 causes the ZUI system 1500 displays a history editing window that is shown in FIG. 20.

The ZUI system 102 uses blocks as information units. Each block has a unique ID number, and can be referenced using the ID number. The ID number is not a file path. Accordingly, each block can be referenced and re-referenced from anywhere in the system. To move a ZUI block from one location to another, the user only needs to change a reference of one block to the new location. All occupant blocks referenced to that specific host block then relocate automatically. In Microsoft Windows, a folder can be moved from one place to another. However, the path for each file in that folder has to be revised as well. Reference to a block can be extracted and shared by, for example, E-mails and text messages, to an external user. Moreover, each block has other secondary attributes; and user can set to display any other relevant information, such as author, date created, etc. Block information can be shared internally within the system, or externally with other systems via, for example E-mails.

ZUI blocks can frame any type of data (text, video, database, running application, home screen of another device, etc.), and display as many objects as physically possible. Other products can have multiple objects displayed at the same time, but their number of objects is limited.

The present zooming user interface uses blocks with infinite inner space, where every block has its own infinite inner space. The space in each block can be divided as many time as needed to fit all information or occupant blocks. Every block can be scaled to the full workspace matching the size of the physical display screen, and act as the main block regardless of its host block or same level occupant blocks.

The zooming user interface can include unlimited number of information blocks without conflict between them. Regardless of their content, ZUI blocks can be grouped by users to their preferences. The ZUI system 102 treats all blocks the same way regardless of their types. In other words, users of the ZUI system 102 can easily group and structure all relevant data in a more natural way (meaning the way we humans organize data in our brain). Information can be found and accessed using any hint (such as name, date, project, location) with all user defined significant details located next to it.

Microsoft Windows allows grouping by placing objects into one parent folder. However, it can only work with files and folders. In contrast, within the ZUI system 102, data is standardized, grouped and placed in one host block. It can take any form or any number of forms. The same data can be represented via different mechanisms. For example, data can be shown as raw data, icon representing datatype and graphs. Furthermore, drawings can be displayed from different prospective of visual representation of the data. For example, regular files can be grouped with web pages, streaming video, remote desktop view, interfaces of external devices, etc.

Microsoft Windows uses files and folders, which are two completely different entities and cannot be converted into each other. Microsoft Windows has to process folders and files via different mechanisms. In contrast, ZUI blocks are uniform units. They can contain data and other blocks, or be part of another block. All ZUI blocks are standard, and are processed the same way. Moreover, ZUI blocks can be easily moved, separated or merged into each other.

ZUI blocks are referenced by ID. Any block can be accessed and reference in its host block. Unlike other solutions, there is no absolute path to a block through multiple other blocks. Working with documents is made easier by ZUI blocks. In the ZUI system 102, the work on documents is from the bottom to top, because a user is allowed to operate on bottom level blocks without accessing their host blocks. External users can be granted access to one block alone, without accessing right to its host block or occupant blocks. In contrast, to work on a document in Microsoft Windows, a user has to have access to the drive and all folders where the file is stored.

The system can automatically generate blocks. For example, to show news, show search results in one block, pinned blocks (described later), or as a result of background scripts, change a view of an object or further break down an object. For example, a document file can be shown in one block, or broken down into pages or chapters and shown in multiple blocks.

In a further implementation, the system 100 incorporates gesture controls for receiving input data that is traditionally entered using, for example, mouse and keyboard. The gesture controls obtains input data from, for example, gesture, head movement and eye movement, voice, etc.

The system further supports multiscreen and multi-space features. Each user can have multiple spaces, each of which works independently. For example, after a screen is divided into two, navigating in one does not affect the content of other space. Furthermore, a space can extend to unlimited number of screens. Multiple users can work on one computer screen, each having his own space, or sharing one space. For example, working on a billboard can be done simultaneously by multiple users with each user working in his own section.

The system 100 is a client-cloud system where data can be stored on a local hardware device that the user is operating or any combination of local and remote systems and devices connected together constantly or in sessions. The network operations are performed by the ZUI system 100 in the background without direct commands from the user. The user, system administrators or algorithms can set different update preferences varying how much bandwidth should be used, how much local storage, how often should various parts be updated. Caching can be combined with data duplication, distributed storage, content merging, etc. The system 100 can be built on a distributed database. The global addressing system based on UUIDs where each block has an ID independent from its physical location makes the distributed system 100 feasible. In such a case, all user interface operations and all data processing operations are implemented in a separate layer from the data handling layer. There are no systems currently in use that implement layer-based architecture for data storage, processing and handling.

The local system can store cached versions of blocks, attached binary objects, block attributes and other information about them. The cache can be updated in the background based on the history of user activity or activity on the server such as block updates. Cached versions can be modified (such as lower resolution, shortened or compressed) versions of the original content. Smart caching can result in true background data transmission with zero or even negative perceived latency. The distributed storage is based on the eventual consistency model with support for change queueing, asynchronous processing, automatic conflict resolution and retroactive writing where operations are performed on objects (such as blocks) that have unconfirmed status with the possibility to track propagation related changes and correct them later if the block is reverted to a different value. The system can be ran on different network architectures, including serverless, P2P, distributed, blockchain based systems. Public and private clouds can be used. Channels alternative to the Internet (such as local Bluetooth links, sound, optical) can be used for connecting together local screens or devices and exchanging data between them.

Each block can be manipulated at any moment of time, like natural interface, without switching screens. In conventional systems, a user has to switch between software applications. In the system 100, a user can do any operation to any block (or any number of blocks) at any given moment. For instance, the user can activate unlimited number of brocks, update, relocate, and group any number of blocks. Moreover, the user can input text or other data into multiple blocks without a need to switch between applications or blocks.

Blocks can contain formulas and scripts. Information in blocks can be created or updated as a result of the given formulas or scripts. External programs can be created and run in any block.

The system 100 further implements thematic blocks. For instance, the system 100 integrates with E-mails, calendar, contact list, etc. E-mails can be transported into the system using standard protocols (such as IMAP, POP3). A message is placed as a block of a specific type. Attachments form occupant blocks. Various message attributes are copied into block attributes. Several block representations are available, such as basic text, rich text (such as HTML), message source. Messages from E-mail accounts are placed in the inbox block. For each E-mail account, a separate inbox block is created. They can be combined easily using standard interface mechanisms. Filters, smart blocks based on filters and automatic message routing can be specified by a user. Standard notification mechanisms are used to inform the user about incoming mail or other events. Messages can be moved from the inbox, and can be transformed into tasks and reference libraries. They can also be moved anywhere in the interface. Automatic sorting and clusterization can be used in additional to manual sorting. Other users can be given a direct link to the inbox block, making it possible for them to place messages to the user directly without going through the email system.

In addition to ZUI blocks that are visually displayed to the user, there may be other visual elements that are related to said blocks. These elements can form a separate layer that is overlaid on top of the main content layer containing ZUI blocks. This overlay can include such elements as heatmaps, navigation trails, “breadcrumbs”, active zones, indicators of user activity, change tracking and other elements. The overlay is laid out and drawn using different algorithms from the main content layer. Blocks in the main content layer and the overlay objects are connected using their positions and can affect each other. Objects from the overlay can display information passively, be dynamically updated and be interactive allowing user interaction with them (such as change, activation, display, affecting connected blocks from the content layer, navigation, etc.). There can be other layers in addition to these two. One example is the background layer that can show design elements such as a wallpaper or content currently hidden or outside of the active area in a graphically modified form. Other layers are also possible.

Blocks can be temporarily pinned and fixed on a part of the space. In such a case, the blocks are termed herein as pinned blocks. Pinning enables working with important information on the go, and can be initiated by a user or automatically by the system 100 when, for example, the user receives a new E-mail or alert message.

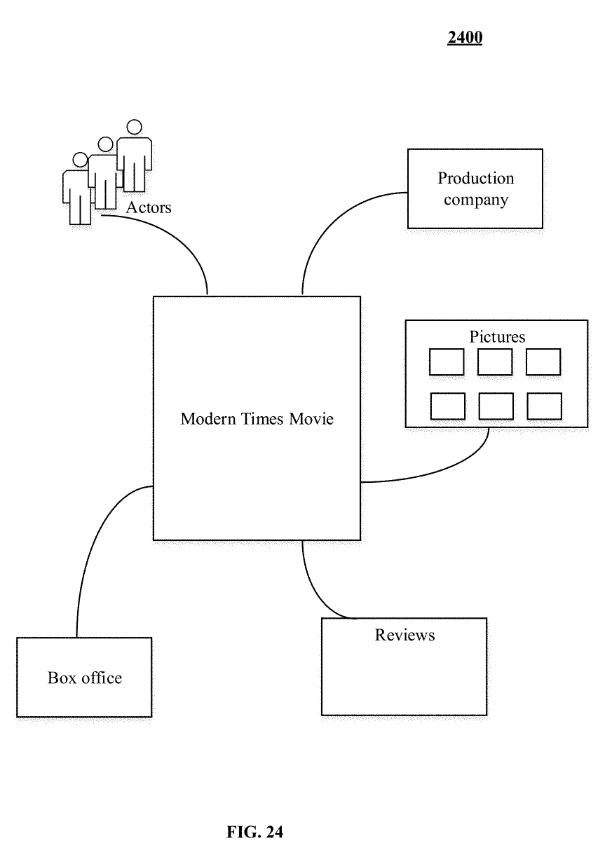

Horizontal connections between blocks. Blocks can have associations. Associations work similarly to portals, but are not physical inserts. For example, movie block can have associations to blocks containing information about people playing (i.e., casting) in the movie, the producing studio, pictures from the production, reviews, budget and box office information, etc. Associations are presented with lines to outside blocks, can be turned on or off, and easily navigated to that specific association block. Association lines can have information associated to them. The horizontal connects are further illustrated in FIG. 24.

All basic operations with ZUI blocks do not require access to blocks they contain. ZUI blocks can be moved or copied even if their content is not available. In other alternatives, full access is required to copy or move a file. If a ZUI block is removed, added or resized, the content of its host block and occupant blocks are automatically re-scaled.

Obviously, many additional modifications and variations of the present disclosure are possible in light of the above teachings. Thus, it is to be understood that, within the scope of the appended claims, the disclosure may be practiced otherwise than is specifically described above.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A zooming user interface system running on a computer, said zooming user interface system comprising:
1) a plurality of blocks including host blocks and occupant blocks, a subset of blocks within said plurality of blocks displayed on a screen of said computer, each occupant block anchored in a corresponding host block, each occupant block being a host block to zero or more other occupant blocks anchored in said occupant block, at least one occupant block within said occupant blocks being a host block to one or more other occupant blocks anchored in said at least one occupant block, wherein blocks within said plurality of blocks are at more than one block level, wherein each host block and occupant blocks of said host block are at two consecutive levels respectively;
2) a first host block within said plurality of blocks, said first host block having a first set of occupant blocks, said first set of occupant blocks anchored within said first host block, said first set of occupant blocks including a first occupant block, said first occupant block displaying a first data from a first data source; and
3) a second host block within said plurality of blocks, said second host block having a second set of occupant blocks, said second set of occupant blocks anchored within said second host block, said second set of occupant blocks including a second occupant block, said second occupant block displaying a second data from a second data source.

2. The zooming user interface system of claim 1, wherein:
1) each block within said plurality of blocks is adapted to be zoomed; and
2) each occupant block within said first set of occupant block is scaled proportionally when said first host block is zoomed.

3. The zooming user interface system of claim 1, wherein said first occupant block is not zoomed when said first host block is zoomed.

4. The zooming user interface system of claim 1, wherein occupant blocks within said first set of occupant blocks are adapted to be sorted by one or more sorting criteria and occupant blocks within said second set of occupant blocks are adapted to be sorted by one more sorting criteria.

5. The zooming user interface system of claim 1, wherein said first data and said second data are of different data types.

6. The zooming user interface system of claim 5, wherein said data types are video data type, text data type, graphical data types, or text and graphical data types.

7. The zooming user interface system of claim 1, wherein:
1) said second occupant block is copied into a destination block, wherein said destination block is a block within said plurality of blocks; and
2) each occupant block within said second occupant block is copied along with said second occupant block.

8. The zooming user interface system of claim 1, wherein:
1) said second occupant block is moved into a destination block, wherein said destination block is a block within said plurality of blocks; and
2) each occupant block within said second occupant block is moved along with said second occupant block.

9. The zooming user interface system of claim 1, wherein said plurality of blocks includes a portal block and said first occupant block is a referenced block, wherein said portal block displays said first data.

10. The zooming user interface system of claim 9, wherein changes made in said portal block to said first data is reflected in said referenced block.

11. The zooming user interface system of claim 1, wherein said first occupant block is in a viewing mode or an editing mode, and wherein said first data is adapted to be edited in said editing mode and is not adapted to be edited in said viewing mode.

12. The zooming user interface system of claim 12, wherein an edit made to said first data is saved and searchable as an editing history.

13. The zooming user interface system of claim 12, wherein said zooming user interface system includes a computer software application running on said computer, wherein said computer software application is adapted to:
1) receive a user search request for a desired data; and
2) responsive to said search request, search a data source of each block anchored within a current host block.

14. The zooming user interface system of claim 13, wherein said computer software application is further adapted to change said current host block for search when a user zooms out to a higher level host block.

15. The zooming user interface system of claim 1, wherein said zooming user interface system is a distributed system, wherein each block within said plurality of blocks is identified by a universal identifier.

16. The zooming user interface system of claim 1, wherein said first occupant block and said second occupant block form a horizontal connection, wherein said first data is associated with said second data.
